(19) United States
(12) Patent Application Publication
(10) Pub. No.: US 2015/0183919 A1
(43) Pub. Date: Jul. 2, 2015

(54) ADDITIVES FOR SELF-REGENERATION OF EPOXY-BASED COATINGS

(71) Applicants: Marly Grinapel Lachtermacher, Rio de Janeiro (BR); Jorge Fernando Pereira Coelho, Rio de Janeiro (BR); Andre Koebsch, Rio de Janeiro (BR); Pedro Altoe Ferreira, Rio de Janeiro (BR); Victor Solymossy, Rio de Janeiro (BR); Idalina Vieira Aoki, Sao Paulo (BR)

(72) Inventors: Marly Grinapel Lachtermacher, Rio de Janeiro (BR); Jorge Fernando Pereira Coelho, Rio de Janeiro (BR); Andre Koebsch, Rio de Janeiro (BR); Pedro Altoe Ferreira, Rio de Janeiro (BR); Victor Solymossy, Rio de Janeiro (BR); Idalina Vieira Aoki, Sao Paulo (BR)

(73) Assignees: Universidade de São Paulo - USP, Butantã, São Paulo, SP (BR); PETRÓLEO BRASILEIRO S.A. - PETROBRAS, Rio de Janeiro, RJ (BR)

(21) Appl. No.: 14/418,364

(22) PCT Filed: Aug. 29, 2012
(86) PCT No.: PCT/BR2012/000315

§ 371 Date: Jan. 29, 2015

(51) Int. Cl. C08G 12/12; C08L 63/00; C08K 5/103

(52) U.S. Cl. CPC C08G 12/12; C08K 5/103; C08L 63/00

(57) ABSTRACT

Additives are described for use in high solids content epoxy-based corrosion resistant coatings in liquid form, where such additives are composed by microcapsules containing a regenerating agent dispersed in an organic solvent.

The coatings, when additivated with such dispersion, will have the ability to self-regenerate in the event of damages (cracks or scratches) to the applied and cured coating on the metal surface, preventing the propagation of corrosion on the exposed metal surface.

### BACKGROUND OF THE INVENTION

The present invention refers to additives for epoxy-based corrosion resistant coatings, more specifically to additives prepared from the dispersion of microcapsules containing repairing agents in organic solvents. Such additives, when added in liquid form to epoxy-based corrosion resistant coatings, are able to promote coating self-regeneration, after cure, particularly in situations of damage to the coating (cracks or scratches). The coating self-regeneration occurs due to the release of repairing agents contained in the microcapsules-agents that form a new protective coating over the damage, preventing corrosion propagation on the exposed surface.

### DESCRIPTION OF RELATED ART

In the oil industry the corrosion of metal pipelines and fuel storage systems is a permanent concern for operators and engineers. One of the ways to minimize corrosion in refineries and oil exploration and production units is to use corrosion resistant coatings.

Among the corrosion resistant coatings of wider applications in the oil industry there are the epoxy-based coatings in particular due to their excellent electrical, thermal and chemical resistance.

Although epoxy-based coatings have an excellent performance as corrosion resistant coatings, such coatings still present the inconvenience of a low mechanical strength. Damages caused by mechanical action can give origin to localized corrosion on metal surfaces exposed by scratches and cracks. Multiple studies have been carried out with the objective to solve or at least minimize such inconvenience.

A patent no. U.S. Pat. No. 6,075,072, for example, refers to a powder coating containing microcapsules with a corrosion inhibitor. The microcapsules break under impact or other kind of stress or impact applied on the coated surface releasing the corrosion inhibiting agent (benzimidazole, 1-methyl-benzimidazole, thiourea and benzothiazole metal phosphates, among others). Although useful in controlling corrosion, powder coatings, and consequently the microcapsules, are difficult to apply on surfaces to be protected (coating deposition by heat or electrostatic action).

The document JP 2007/162110, in turn, refers to a rust resistant coating containing microcapsules in a 1.0% to 30.0% ratio by weight. The microcapsules contain a rust resistant agent (benzotriazole and tannic acid, among others). In this case, the application of high temperatures for the dispersion of microcapsules in the coating is required in order to promote the merger and integration of the coating to the outer surface of the microcapsule.

Document US 2008/0152815 describes an auto-regenerating coating comprising a commercial coating (e.g., paints) and microcapsules containing a restorative substance composed by a film forming agent (polybutene, phenolic varnishes, etc.), a solvent, and a corrosion inhibiting agent. The microcapsules release the restorative substance when the coating is subjected to any physical stress, thereby minimizing the corrosive process. Although such coatings are able to self-regenerate, the microcapsules dispersed in it are highly unstable in solvents used in known commercial coatings. In this way, the preparation and addition of microcapsules must occur at the time of application, thereby minimizing the destruction of the microcapsules.

Therefore, the technique still requires additives with microcapsules for promoting the self-regeneration of coatings that advantageously exceed the results in terms of stability and ease of application of the additives known for the art, such as those described in detail below.

### SUMMARY OF THE INVENTION

In a broader sense, the present invention refers to additives for high solids content epoxy-based corrosion resistant coatings in liquid form.

Such additives are prepared from the dispersion of microcapsules containing repairing agents in organic solvents.

Epoxy-based corrosion resistant coatings in liquid form, when additivated with that dispersion, will possess the ability to self-regenerate in the event of damages (cracks or scratches) in the applied and cured coating on a metal surface. The coating self-regeneration occurs due to the release of repairing agents contained in the microcapsules-agents that form a new protective coating over the damage, preventing corrosion propagation on the exposed surface.

Additionally, the presentation of the additive in the form of a dispersion of microcapsules in an organic solvent promotes stability and ensures the integrity of the microcapsules over a longer period of time, generally above 30 days, which allows for preparation and storage without the need of immediate use of the microcapsules shortly after preparation.

### DESCRIPTION OF THE FIGURES

FIG. 1 presents an image obtained with an optical microscope using 10× lens of the microcapsules prepared in accordance with the method shown in example 1 after a 3-hour polymerization period.

FIG. 2 presents the images obtained by an optical microscope using 10× lens of the dispersion containing 60% of microcapsules and 40% of solvent in wet film. Being image (A) that obtained after a 1-day storage in a glass bottle and image (B) after a 15-day storage in a glass bottle.

FIG. 3 illustrates the self-regeneration effect by presenting EIS (Electrochemical Impedance Spectroscopy) data represented in Nyquist diagrams, where (▪) represents 1020 carbon steel specimens painted with non-additivated epoxy paint and no induced defect, () specimens painted with non-additivated epoxy paint and with defect, (▴) specimens painted with epoxy paint additivated with 12.8% of microcapsules by weight containing linseed oil, and no defect, (▾) specimens painted with epoxy paint additivated with 12.8% of microcapsules by weight containing linseed oil, with defect (23-hour exposure to air), and (♦) specimens painted with epoxy paint additivated with 12.8% of microcapsules by weight, containing linseed oil, with defect (73-hour exposure to air). The specimens were evaluated after a 1-hour immersion in NaCl 0.1 mol/L.

FIG. 4 illustrates the self-regeneration effect by presenting EIS (Electrochemical Impedance Spectroscopy) data represented in Bode |Z|×log f diagrams where (▪) represents 1020 carbon steel specimens painted with non-additivated epoxy paint and no induced defect, () specimens painted with non-additivated epoxy paint and with defect, (▴) specimens painted with epoxy paint additivated with 12.8% of microcapsules by weight containing linseed oil, and no defect, (▾) specimens painted with epoxy paint additivated with 12.8% of microcapsules by weight containing linseed oil, with defect (23-hour exposure to air), and (♦) specimens painted with epoxy paint additivated with 12.8% of microcapsules by weight, containing linseed oil, with defect (73-hour exposure to air). The specimens were evaluated after a 1-hour immersion in NaCl0.1 mol/L.

FIG. 5 illustrates the appearance of the 1020 carbon steel specimens coated with clear type epoxy resin formulated with 10% of microcapsules by weight containing linseed oil after a 7-day exposure in a saline mist chamber where (a) reference without capsules; (b) after 0 hours; (c) 24 hours, (d) 48 hours, and (e) 72 hours of exposure to air after inducing the defect.

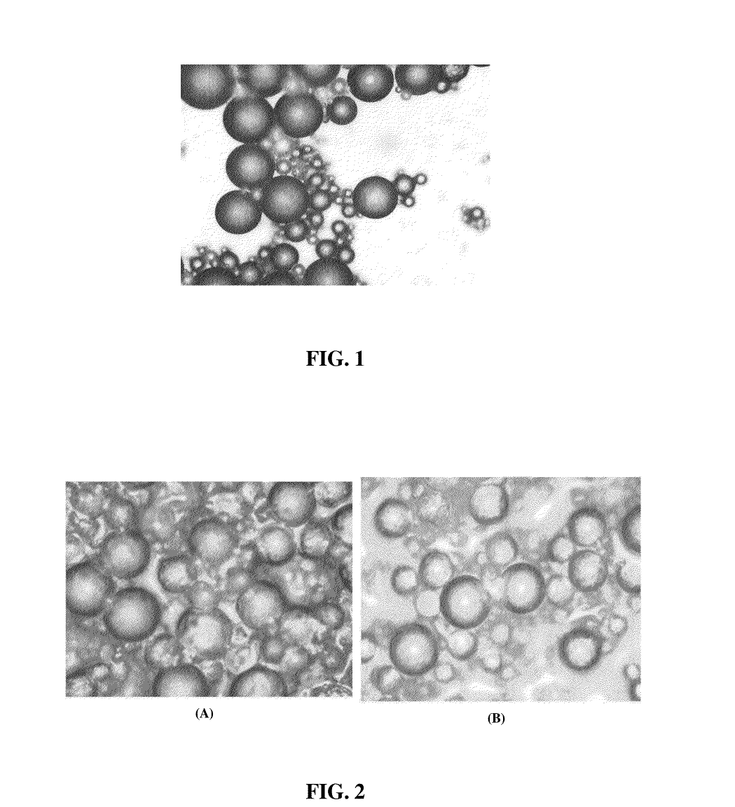

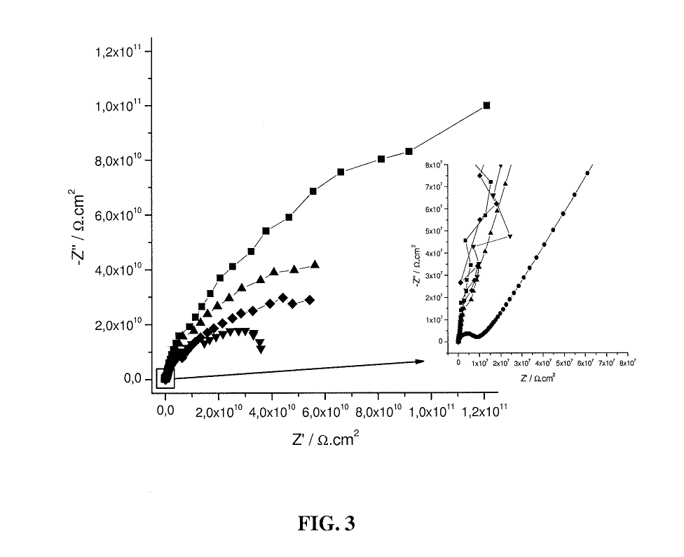

### DETAILED DESCRIPTION OF THE INVENTION

In a broader sense, the present invention refers to additives for high solids content epoxy-based corrosion resistant coatings in liquid form.

Such additives are prepared from the dispersion of microcapsules containing repairing agents in organic solvents.

Epoxy-based corrosion resistant coatings in liquid form, when additivated with that dispersion, will possess the ability to self-regenerate in the event of damages (cracks or scratches) in the applied and cured coating on a metal surface. The coating self-regeneration occurs due to the release of repairing agents contained in the microcapsules-agents that form a new protective coating over the damage, preventing corrosion propagation on the exposed surface.

The additives of the present invention are composed by urea-formaldehyde microcapsules with sizes ranging from 20 to 200 microns containing a repairing agent dispersed in an organic solvent where the concentration of microcapsules dispersed in the solvent is 30% to 60% by weight.

The additives, object of the present invention, will be described below in accordance with the principle of micro-encapsulation by poly-condensation of a polymeric layer at the interface between two phases of a system containing a repairing agent, preferably a lipophylic substance, dispersed in water.

Micro-encapsulation involves the addition of the repairing agent, having added surfactants and/or emulsifiers, to an aqueous solution which, under constant stirring, will lead to the formation of micelles. The addition of hydrophilic monomers, such as urea, formaldehyde and hardening agents, such as: melamine, isocyanates and resorcinol to the repairing agent/surfactant/water mix leads to the formation of a polymeric layer composed of one or more hydrophilic monomers in the micelles interface, and later to the formation of the microcapsules walls containing the repairing agent, typically at a concentration of 10% to 15% of the reactional mix by weight.

Among the useful surfactants for microcapsules formation are: polyvinyl alcohol, acacia gum, nonylphenolethoxylate (Renex 95), dodecyl sodium benzenesulfonate and Silwet 7200, preferably to acacia gum, at concentrations ranging from 0.1% to 0.5% by weight.

The repairing agent must be a substance capable of forming polymeric films when in contact with air for the presence of non-saturations in its chain and having lipophylic characteristics, such as: linseed oil, pre-polymerized linseed oil, alkyd resins containing linseed oil, besides tung oil, fish oil or mixtures of both.

Microcapsules containing those repairing agents are dispersed in an organic solvent, being useful solvents for the present invention: hydrocarbons, alcohols, ketones and ethers.

Those solvents compose the additives object of the present invention by the formation of a stable suspension, ensuring the integrity of the microcapsules for periods of 30 to 40 days which ultimately facilitate their addition to epoxy-based coatings in a ratio of 5% to 20% of the additive by weight in relation to the wet epoxy-based coating, preferably those epoxy-based coatings with high solids content.

### EXAMPLE 1

The following example illustrates the preparation of the preparation of microcapsules containing linseed oil as repairing agent in concentrations between 10% to 15% by weight, additived with drying agents, using acacia gum as surfactant in a concentration in the range of 0.1% to 0.5% by weight.

In a beaker, the repairing agent, water and surfactant are added, controlling speed of agitation in the range of 800 rpm to 3000 rpm during the formation of the emulsion to ensure the stability of the emulsion and to provide constant medium homogenization.

In a later step, after the addition of monomers and hardening agents, the agitation speed is reduced to the range of 100 rpm to 500 rpm so as to facilitate polymerization and to obtain uniform microcapsules.

Table 1 below illustrates a possible composition of the additives described in this invention.

TABLE 1

| COMPONENT | Range % (by weight) |
|---|---|
| Urea | 1-3 |
| Formaldehyde 37 m % | 3-5 |
| Ammonium chloride | 0.1-0.2 |
| Resorcinols | 0.1-0.2 |
| Sodium chloride | 2-3 |
| Acacia gum | 0.1-0.5 |
| Linseed oil | 10-15 |
| Water | 75-85 |

### EXAMPLE 2

The following example illustrates the stability of additives composed of microcapsules containing the repairing agent when dispersed in an organic solvent, specifically a commercial solvent for high solids content epoxy based corrosion resistant coatings in liquid form.

Microcapsules prepared in accordance with the method described in example 1 were dispersed in solvent thus obtaining a fully stable dispersion, in that the integrity of the microcapsules is maintained during application, a very important parameter to avoid migration of the repairing agent through their walls.

FIG. 3 illustrates the obtained dispersion containing 60% of microcapsules and 40% of paint solvent after one day of preparation (FIG. 3A) and after fifteen days (FIG. 3B) of conditioning in wet film, showing good dispersion stability. The dispersion stability is very important for use in paints with high solids content.

### EXAMPLE 3

The following example illustrates the use of additives prepared according to example 2 in the formulation of high solids content epoxy based corrosion resistant coatings in liquid form.

From the dispersion containing the microcapsules obtained according to example 2 and the addition of those at a concentration of 5% to 20% (by weight) in wet base to high solids content epoxy based corrosion resistant coatings in liquid form; specimens were painted with a thickness in the range of 500 microns, using different dispersion/solvent mix compositions whose dry layer thickness and quantity of capsules in wet base are illustrated in Table 2 below.

TABLE 2

| | Amount of | Amount of wet | |
|---|---|---|---|
| | dispersion (capsule + | based capsules | Dry layer |
| Specimen | solvent) % (m/m) | % (m/m) | thickness μm |
| Cp1 | 0 | 0 | 477 ± 19 |
| Cp2 | 10 | 6.4 | 478 ± 25 |
| Cp3 | 20 | 12.8 | 491 ± 27 |

### EXAMPLE 4

The following example illustrates the validation of the self-regeneration effect of high solids content epoxy based corrosion resistant coatings in liquid form when additived with the dispersion of microcapsules in solvent, object of the present invention.

The specimens prepared according to example 3 were submitted to the action of an indenter, damaging the surface. The electrochemical impedance of carbon steel coated with additived epoxy-based paint was subsequently measured after different times of exposure to air of the specimens subjected to the indenter action. This way, there is the formation of coating by the repairing agent released from the microcapsules.

The damage caused by the indenter ensures reproducibility in the area exposed to different conditions. Impedance measurements were made in saline environment, NaCl concentration of 0.1 mol/L m/m, at 1-hour and 24-hour periods after immersion in electrolyte (NaCl).

Positive references were measured in additived paint or not, without imperfections. The negative reference for comparison was made in non-additived paint and with indenter induced damage after the same period of time of immersion and exposure to air.

Measurements were made using a 15 mV amplitude sinusoidal perturbation around the open circuit potential. The frequency range was 50 kHz to 5 MHz with ten steps per frequency decade. A 3-electrode electrochemical cell was used with the coated carbon steel in the paint region containing the damage, the work electrode, and the Ag/AgCl/KCl sat electrode was used as the reference electrode with a large area platinum sheet used as counter-electrode.

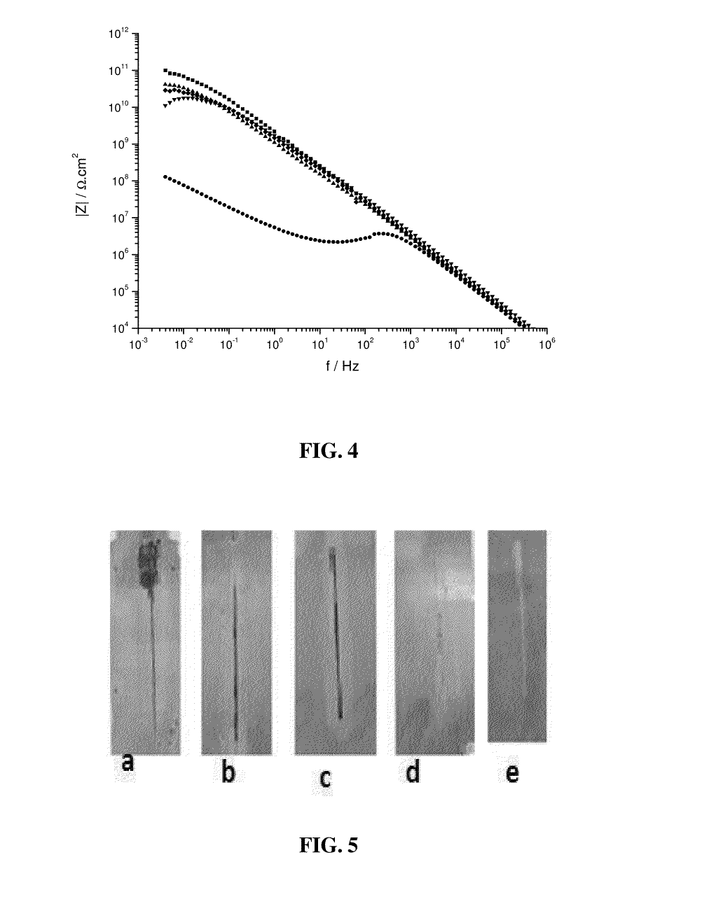

The self-repairing effect can be seen in FIG. 4 with the EIS data represented in a Bode |Z|×log f diagram. Note that for the damaged sample and with non-additived paint, the impedance falls three orders of magnitude compared to the sample without imperfections. In the additived sample (12.8% of microcapsules by weight) and without imperfections the impedance value of the module is somewhat lower than for the non-additived sample. This is due to the presence of microcapsules which creates conditions for the formation of pores and defects in the paint, causing a decrease of one order of magnitude in the impedance module.

As for additived samples (12.8% of microcapsules by weight), the sample with imperfections after a 24-hour period of exposure to air shows the impedance module in a condition near that of the sample without imperfections indicating that the forming of the self-repairing film occurred, restoring the coating condition close to the original. Thus, the self-repairing effect is illustrated.

FIG. 5 shows the appearance of the specimens coated with a clear type paint after a 7-day exposure in a saline mist chamber. The area of the sectional shape defect is more protected from corrosion in the specimens coated with additived paint with 10% of microcapsules by weight when compared to specimens coated with paints without microcapsules, and the protection increases for longer exposure times to air after the inducement of the defect. This exposure to air promotes radical polymerization promoted by the oxygen present in the air, confirming the self-repairing effect.

1. An additive for self-regeneration of epoxy-based coatings, comprising urea-formaldehyde microcapsules with sizes ranging from 20 to 200 microns containing a repairing agent dispersed in an organic solvent where the concentration of microcapsules dispersed in the solvent is 30% to 60% by weight.

2. The additive for self-regeneration of epoxy-based coatings according to claim 1, wherein the repairing agent is a lipophylic substance dispersed in water.

3. The additive for self-regeneration of epoxy-based coatings according to claim 1, wherein the repairing agent contained in the microcapsules is in a concentration ranging from 10% to 15% by weight of the reaction mass.

4. The additive for self-regeneration of epoxy-based coatings according to claim 1, wherein the repairing agent is selected from the group consisting of: linseed oil, pre-polymerized linseed oil, alkyd resins containing linseed oil, besides tung oil, fish oil, and mixtures thereof.

5. The additive for self-regeneration of epoxy-based coatings according to claim 1, wherein the organic solvent is selected from the group consisting of: hydrocarbons, alcohols, ketones and ethers.

6. The additive for self-regeneration of epoxy-based coatings according to claim 1, said additive being added to an epoxy-based coating epoxy in a ratio of 5% to 20% of the additive by weight in relation to the epoxy-based coating in a wet base.

7. An epoxy-based coating with a high solids content, comprising the additive for self-regeneration of epoxy-based coatings according to claim 1.
